(19) United States
(12) Patent Application Publication
(10) Pub. No.: US 2002/0073187 A1
(43) Pub. Date: Jun. 13, 2002

(54) Method and apparatus for time decay monitoring of application, network and system behavior

(76) Inventor: Freeman Leigh Rawson III, Austin, TX (US)

Correspondence Address: Duke W. Yee, Carstens, Yee & Cahoon, LLP, P.O. Box 802334, Dallas, TX, 75380, US

(21) Appl. No.: 09/731,613

(22) Filed: Dec. 7, 2000

(51) Int. Cl. G06F 15/173

(52) U.S. Cl. 709/223

(57) ABSTRACT

A method and apparatus for time-decay monitoring of application, network and system behavior is provided. With the method and apparatus, a period at which management requests are sent from a management device to a managed system is varied based on a status of the managed system. While the managed system is operating normally or within specified parameters, the period is time-decayed so that it becomes longer until a maximum period is reached. If the managed system begins to operate irregularly or unexpectedly, the period is decreased so that the period becomes smaller until a minimum period is reached.

### RELATED APPLICATION

The present invention is related to commonly assigned and co-pending U.S. patent application Ser. No. ______ (Attorney Docket No. AUS920000420US1) entitled “METHOD AND APPARATUS FOR PARTITIONING SYSTEM MANAGEMENT INFORMATION FOR A SERVER FARM AMONG A PLURALITY OF LEASEHOLDS,” filed on even date herewith, and which is hereby incorporated by reference.

### BACKGROUND OF THE INVENTION

1. Technical Field

The present invention is directed to a method and apparatus for time decay monitoring of application, network and system behavior.

2. Description of Related Art

Thin servers have been developed to provide a specialized server that is typically cheaper than traditional servers and easier to install and use than traditional server apparatus. A thin server is a network-based computer specialized for some function such as a print server, ISDN router or network attached storage (NAS). Web server software is often built in allowing management and control via a Web browser residing on any client platform in the network.

Farms or clusters of thin servers are being used to provide web-based application services as a single system from an administrative perspective while maintaining multiple execution images. In such systems, management involves both monitoring by a management subsystem or server as well as information and alert generation by the components being managed. Although alerts are often generated based on the occurrence of an event, most of the management network traffic and processing is the result of periodic data collection, command and control actions or monitoring activities. The period for each of these activities is constant, incurring a constant overhead cost due to the amount of processing required to perform the actions as well as the amount of traffic being generated and sent over the network.

However, since modern systems and networks are relatively reliable and stable, with some exceptions, there are times during which system management functions create a larger burden on the system than any benefit obtained from them. Accordingly, it would be beneficial to have a method and apparatus for adjusting monitoring intervals to take into consideration the relative stability of the system.

### SUMMARY OF THE INVENTION

The present invention provides a method and apparatus for time-decay monitoring of application, network and system behavior. With the method and apparatus of the present invention, the period at which management requests are sent from a management device to a managed system is varied based on a status of the managed system. While the managed system is operating normally or within specified parameters, the period is time-decayed so that it becomes longer until a maximum period is reached. If the managed system begins to operate irregularly or unexpectedly, the period is decreased so that the period becomes smaller until a minimum period is reached.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a distributed data processing system according to the present invention; and

FIG. 2 is a flowchart outlining an exemplary operation of the present invention.

### DETAILED DESCRIPTION OF THE PREFERRED EMBODIMENT

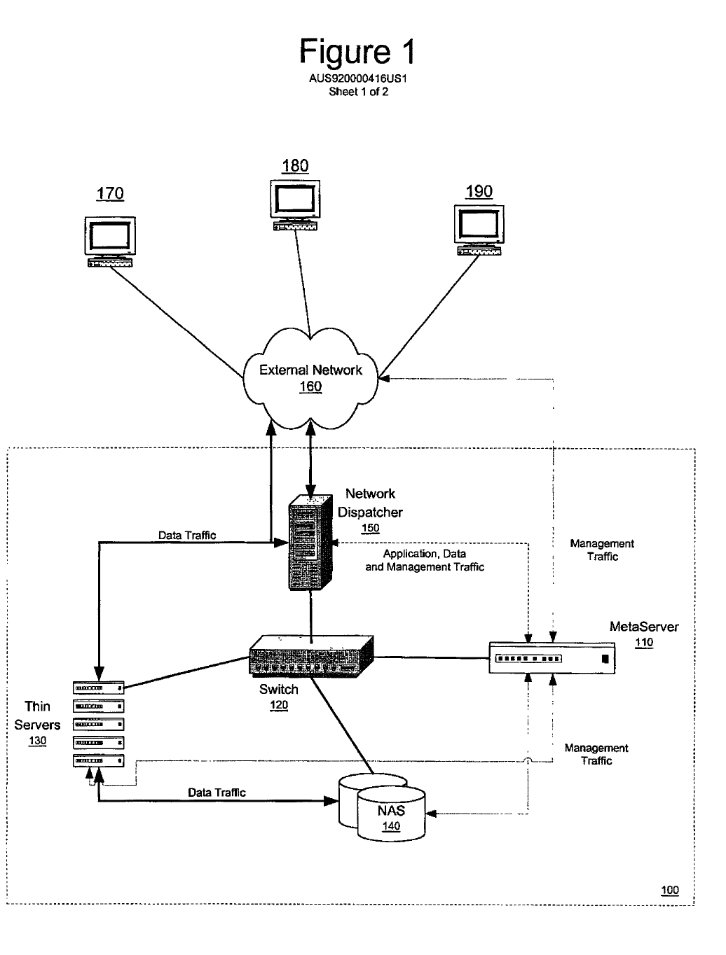

FIG. 1 is an exemplary block diagram illustrating a distributed data processing system according to the present invention. As shown in FIG. 1, the distributed data processing system includes a metaserver 110, a switch 120, one or more thin servers 130, network attached storage (NAS) 140, network dispatcher 150, external network 160, and one or more client devices 170-190. The metaserver 110, switch 120, thin servers 130, NAS 140 and network dispatcher 150 are part of a local area network 100 coupled to the external network 160. In FIG. 1, data flow is denoted by lines having arrow heads while actual physical connections are denoted by solid lines. In actuality, all data packets are routed through the switch 120.

The distributed data processing system shown in FIG. 1 is illustrative only. The particular architecture and elements shown in FIG. 1 are not intended to place any limitations on the architecture and elements used with the present invention. Rather, the distributed data processing system may have many other architectures and may include other elements in addition to, or in replacement of, the elements shown in FIG. 1 without departing from the spirit and scope of the present invention.

In the data processing system of FIG. 1, the thin servers 130 provide specialized applications to client devices 170-190 via the external network 160 and the network dispatcher 150. The thin servers 130 may provide any number of different applications, including print applications, database applications, web-serving applications, and the like.

The external network 160 may be any type of data network known to those of ordinary skill in the art. The external network 160 may be, for example, the Internet, an intranet, a wide area network (WAN), local area network (LAN), wireless data network, satellite data network, or the like. The external network 160 may also be any combination of the above.

The client devices 170-190 may be any type of computing device capable of accessing the thin servers 130 via the external network 160 and the network dispatcher 150. The client devices 170-190 may be, for example, a personal computer, laptop computer, personal digital assistant (PDA), data network capable wireless communication device, and the like. The client devices 170-190 may access applications provided by the thin servers 130 using, for example, a web browser application or the like.

The network dispatcher 150 performs workload balancing with regard to the thin servers 130 with the goal being to avoid looking at every packet, especially every packet sent back by the thin servers 130. The network dispatcher 150 dispatches jobs or transaction requests to the thin servers 130 and the NAS 140. The network dispatcher 150 essentially provides a mechanism through which job or transaction requests may be sent to applications running on the thin servers 130. The responses to these job or transaction requests are supplied directly by the thin servers 130 through the switch 120 to the external network 160 and hence to the clients 170-190.

The NAS 140 is a specialized file server that connects to the network. The NAS 140 uses traditional local area network (LAN) protocols, such as Ethernet and TCP/IP and processes only file I/O requests such as Network File System (NFS)(UNIX) and Server Message Block (SMB)(DOS/Windows).

The switch 120 is an electronic device that directs the flow of data from one side of the switch to the other. The switch 120 may be any type of data switching device known to those of ordinary skill in the art. For example, the switch 120 may be an Ethernet switch, a hub, a router, or the like. The switch 120 serves to route data and message traffic to appropriate devices 110, 130, 140 and 150.

The metaserver 110 performs the function of managing the devices in the local area network, e.g., the switch 120, the thin servers 130, the NAS 140 and the network dispatcher 150. In managing these devices, what is meant is that the metaserver 110 performs management functions including collecting data to maintain statistics of historical interest and to monitor the current state of the devices. The metaserver 110 may be a server, as is generally known in the art, or may be a specialized thin server that is used to perform management functions. In the depicted example, the metaserver 110 is a specialized thin server.

In the distributed data processing system shown in FIG. 1, the two main goals are to (1) minimize the overall performance impact of management by off-loading the management processing to the metaserver 110; and (2) to reduce the total cost of the system by using a single network for both application and management traffic. However, by centralizing the management functions in the metaserver 110, two potential bottlenecks are created. First, the metaserver itself has only a particular capacity for doing the processing required by the management function. Second, moving the management function to a central location increases the amount of traffic on the network, and with a single network, that traffic may delay other traffic such as that required to perform the application(s). As a result, due to these limitations of the network and the metaserver 110, the metaserver is limited in the number of thin servers 130 and NAS 140 that it can manage.

The metaserver shown in FIG. 1 operates based on instructions stored, for example, in local memory or storage. These instructions allow the metaserver to operate in a manner that takes into consideration the stability of the local area network when determining when to perform management functions. This determination of when to perform management functions will be described in greater detail hereafter.

The present invention provides a mechanism by which the amount of management traffic is reduced during times when the local area network and the devices are operating in a stable manner while allowing for greater levels of management during times when it is determined that the overall system is operating in an unexpected manner. By minimizing the management traffic during times of normal operation, the likelihood of a bottleneck situation occurring is minimized and the number of monitored servers may be increased.

With the present invention, if the behavior and load on the local area network are determined to be within expected parameters, the period of management functions is increased, thereby decreasing the frequency of the monitoring activity of the metaserver 110. Thus, overhead of the system is reduced. On the other hand, when one or more of the thin servers or the local area network behaves in an unexpected manner, either by generating an alert or receiving an unexpected response to a management inquiry, the periods of the various management activities are reduced. The amount of reduction depends on the nature of the unexpected manner of operation and/or the duration of the unexpected operation.

As an example of the type of monitoring which this invention applies, consider the collection of information regarding the number of hypertext transport protocol (http) requests being completed per second by some number N of web-serving appliances. Under a particular load of inbound requests per second L, each server appliance is expected to receive approximately L/N requests per second. To ensure that this is happening, the metaserver may send to each web-serving appliance a request to transmit the number of requests per second that it is receiving. If the values returned are all sufficiently close to L/N, the metaserver can assume that at least this part of the system is operating within normal parameters. However, if some of the values are radically different from L/N, then the metaserver has detected an out-of-specification condition.

As described above with regard to the specific example provided, the metaserver sends out management messages to monitored systems and devices, such as thin servers 130, requesting that they respond with various information detailing their operational history and/or current operational status. For example, the metaserver may send a request to a thin server requesting that the thin server indicate the number of access requests received from client devices and the number of times the thin server failed to provide the requested access.

Based on this information, the metaserver may determine whether or not the thin server is operating within acceptable parameters. For example, if the number of times the thin server failed to provide the requested access exceeds a predetermined maximum acceptable threshold, the metaserver may determine that the thin server is not operating within normal parameters.

With the present invention, the period at which these monitoring request messages are sent to monitored systems is variable based on the current operational status of the local area network and/or the systems attached to the local area network. If the local area network and coupled systems are operating in a stable and expected manner, the period between monitor request messages is longer. If the local area network and coupled systems are operating in an unexpected or unstable manner, the period between monitoring request messages is shorter. In this way, the management traffic is made variable based on a current operating status of the monitored network and systems.

Assume that the set of monitoring or information gathering operations performed on or for a particular target system T is {O₀, O₁, . . . , Oₙ}. The period description PDₖ of monitoring operation Oₖ is <Pₘᵢₙ, Pₘₐₓ, D, B> wherein Pₘᵢₙ is the minimum monitoring period (the shortest interval at which Ok is to be performed), Pₘₐₓ is the maximum monitoring period (the longest interval between Oₖ monitoring operations), D is the decay value (the value added to the current period of Oₖ as the rate of monitoring is reduced or as the interval between successive operations is increased), and B is the boost value (the value subtracted from the current period of Oₖ as the rate of monitoring is increased). Also assume C(Oₖ) is a predicate representing any condition that, when true, indicates an abnormal situation and which, when false, indicates the restoration of a normal state of system operation. Let Pₖ be the period currently being used for Oₖ, and let R be the rate of change of the period.

When the metaserver begins monitoring the state of the target system T, the metaserver uses the Pₘᵢₙ value from PDₖ to set the time between successive monitoring operations Oₖ. Using the rate of change of the period R, the metaserver decays the period of Oₖ by adding the decay value D to the period Pₖ. Thus, at time R, the period Pₖ becomes Pₘᵢₙ+D. This process is repeated every R time units until Pₖ>=Pₘₐₓ at which point the period Pₖ is set to the maximum period Pₘₐₓ.

If at any step of the decay process or subsequent to its conclusion, the predicate C(Oₖ) becomes true, the decay is undone using the boosting procedure described below. In order to minimize the possibility of packet storms, the initial times at which the monitoring operations Oₖ are done are spread over an interval and, where feasible, the monitoring operations for the different targets are also spread over an interval of time. (Packet storms are relatively sudden and dramatic increases in the number of packets being transmitted on the network. Packet storms cause network congestion and can lead to capacity problems as well as forcing the network into transmission back-off. Packet storms are associated with spikes in request traffic, events such as the reload of a large number of thin servers simultaneously, and certain types of network errors that cause continual retransmission. In the worst cases, packet storms cause denial of service and loss of access.)

Normal behavior for the target system T and monitoring operations Oₖ is deemed to end when the predicate C(Oₖ) transitions from false to true. When this occurs, the decay process is reversed by a boosting procedure, starting at the time when the change in the truth value of the predicate C(Oₖ) is first detected. At the time that the change is detected, the period Pₖ is decremented by the boost value B, and this is repeated every R time units until Pₖ<=Pₘᵢₙ at which point the period Pₖ is set to Pₘᵢₙ and the boosting process stops. If at any time during the boosting process or subsequent to its conclusion, the predicate C(Oₖ) changes back to false, the boosting stops and is replaced with the decay process discussed above.

The decay D and the boost B may be separate values since it may be the case that the particular monitoring operation Oₖ may monitor a target system that is very critical. Thus, if anything goes wrong with the critical target system, the minimum period monitoring may need to begin again immediately. By setting B>=Pₘₐₓ−Pₘᵢₙ, a single boost instantly may reduce the monitoring period to its minimum value.

As described above, the decay value D and boost value B are used to change the period of the monitoring functions being performed by the metaserver. The decay value D and boost value B may themselves be constant or variable. The decay value D and boost value B may be variable based on any number of different criteria including, for example, the nature of the system, operating condition of the system, elapsed time since an unexpected condition has occurred, or the like. The decay value D and boost value B may be preset or calculated based on any type of functional relationship.

The present invention is not limited to the mechanism described above. Many modifications may be made without departing from the spirit and scope of the present invention. For example, although the description above treats the predicate C(Oₖ) as a predicate that changes from false to true when something goes wrong or is out of normal operating specifications, the predicate sense may be reversed so that it is the transition of a predicate C(Oₖ) from true to false triggers the boost while the maintenance of truth allows the decay to continue. Moreover, the predicate C(Oₖ) could have numerical values and defined thresholds rather than simply truth values. Inequality relationships may be used between the predicate C(Oₖ) and its thresholds to convert the predicate back to a truth-valued predicate. Other extensions of the present invention, may be made without departing from the spirit and scope of the present invention.

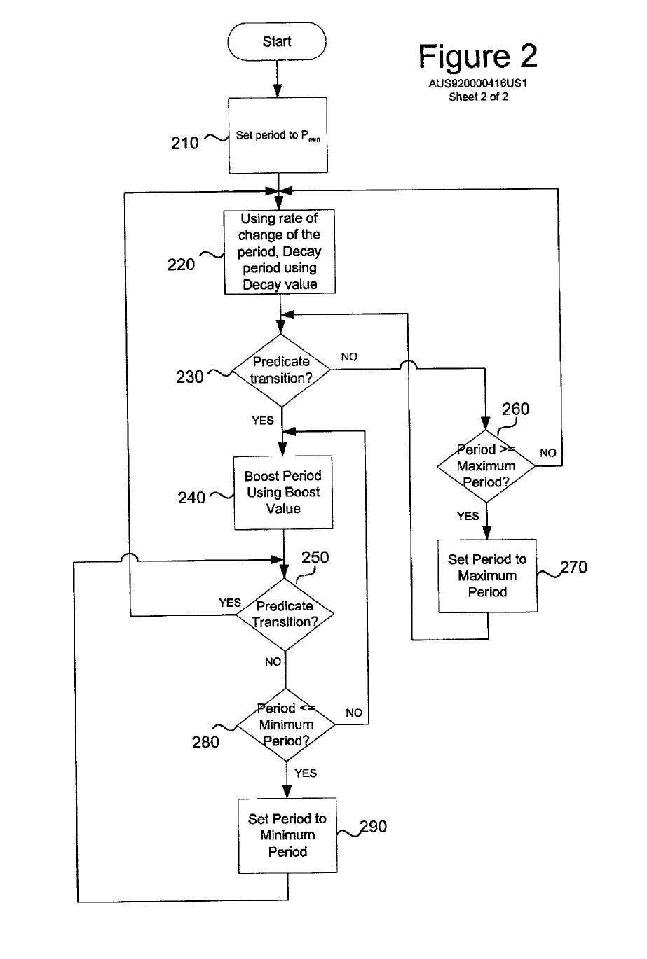

FIG. 2 is a flowchart outlining an exemplary operation of the present invention. As shown in FIG. 2, the operation starts with setting the management period to Pₘᵢₙ (step 210). Thereafter, the period is decayed using the rate of change of the period R and the decay value D (step 220). A determination is then made as to whether a predicate of the monitored system transitions from a first value to a second value (step 230). If not, the operation continues with step 260.

If there is a transition of the predicate, the decay process is reversed and the period is boosted by decrementing the period by the boost value (step 240). A determination is made as to whether or not the predicate again transitions (step 250). If there is a predicate transition, the operation returns to step 220.

If there is no predicate transition in step 230, a determination is then made as to whether the period is greater than or equal to the maximum period (step 260). If so, the period is set to the maximum period (step 270) and the operation returns to step 230. If the period is less than the maximum period, the operation returns to step 220.

If there is no predicate transition in step 250, a determination is made as to whether the period is less than or equal to the minimum period (step 280). If so, the period is set to the minimum period (step 290) and the operation returns to step 250. If the period is less than the maximum period, the operation returns to step 240.

There are a number of advantages to time-decay monitoring over simply using fixed period monitoring. From the perspective of monitoring a large number of server appliances in a cluster or farm over a single network, time-decay monitoring is a way of reducing the network expense of moving management computation from the managed server appliances to the management appliance. With fixed-period monitoring, the network bandwidth consumed by monitoring is approximately constant no matter how well the network and the systems are operating and is dependent on the level of detail of monitoring operations, the number of different monitoring operations, and the number of monitored systems.

While it is still the case with time-decay monitoring that the network overhead is a function of the number of monitoring operations per target system and the number of target systems, the monitoring rate is much lower, allowing one to monitor more operations per target system and to handle more target systems with the same amount of average network bandwidth. On the other hand, the use of time-decay allows for significantly shortened monitoring intervals in critical situations below what would be regularly used. This permits a more careful monitoring of targets in failure or out-of-specification operating conditions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of managing a system, comprising:
determining a period for sending management information requests to the system;
sending a management information request to the system in accordance with the determined period; and
performing management of the system based on a response received from the system, wherein the period for sending the management information request is determined based on an operating status of the system.

2. The method of claim 1, wherein determining a period for sending management information requests includes time-decaying the period if the operating status of the system is determined to be normal.

3. The method of claim 1, wherein determining a period for sending management information requests includes increasing the period by a decay amount if the operating status of the system is determined to be normal.

4. The method of claim 1, wherein determining a period for sending management information requests includes reducing the period by a boost amount if the operating status of the system is determined to be other than normal.

5. The method of claim 3, wherein the decay amount is variable.

6. The method of claim 4, wherein the boost amount is variable.

7. The method of claim 1, wherein the operating status of the system is determined based on a value of a predicate function.

8. The method of claim 8, wherein the steps of determining, sending and performing are performed by a specialized management thin server or server appliance.

9. An apparatus for managing a system, comprising:
determination means for determining a period for sending management information requests to the system;
sending means for sending management information requests to the system in accordance with the determined period; and
management means for performing management of the system based on the responses received from the system, wherein the period for sending the management information requests is determined based on an operating status of the system.

10. The apparatus of claim 9, wherein the determination means determines a period for sending management information requests by periodically increasing the period by a decay amount if the operating status of the system is determined to be normal.

11. The apparatus of claim 9, wherein the determination means determines a period for sending management information requests by periodically reducing the period by a boost amount if the operating status of the system is determined to be other than normal.

12. The apparatus of claim 11, wherein the decay amount is variable.

13. The apparatus of claim 12, wherein the boost amount is variable.

14. The apparatus of claim 9, wherein the operating status of the system is determined based on a value of a predicate function.

15. The apparatus of claim 9, wherein the apparatus is a management server appliance or thin server.

16. A computer program product in a computer readable medium for managing a system, comprising:
first instructions for determining a period for sending management information requests to the system;
second instructions for sending a management information request to the system in accordance with the determined period; and
third instructions for performing management of the system based on a response received from the system, wherein the period for sending the management information request is determined based on an operating status of the system.

17. The computer program product of claim 16, wherein the first instructions for determining a period for sending management information requests includes instructions for time-decaying the period if the operating status of the system is determined to be normal.

18. The computer program product of claim 16, wherein the first instructions for determining a period for sending management information requests includes instructions for periodically increasing the period by a decay amount if the operating status of the system is determined to be normal.

19. The computer program product of claim 16, wherein the first instructions for determining a period for sending management information requests includes instructions for periodically reducing the period by a boost amount if the operating status of the system is determined to be other than normal.

20. The computer program product of claim 18, wherein the decay amount is variable.

21. The computer program product of claim 19, wherein the boost amount is variable.

22. The computer program product of claim 16, wherein the operating status of the system is determined based on a value of a predicate function.

23. The computer program product of claim 16, wherein the system is one or more of a thin server and a server appliance.

24. The computer program product of claim 23, wherein the computer program product is implemented in a management server appliance or thin server.
